(19) United States
(12) Patent Application Publication
(10) Pub. No.: US 2017/0149613 A1
(43) Pub. Date: May 25, 2017

(54) DISTRIBUTING BANDWIDTH CAPACITY OF A MOBILE COMMUNICATION NETWORK

(71) Applicant: Aquto Corporation, Boston, MA (US)

(72) Inventor: Nicolas Girard, Boston, MA (US)

(21) Appl. No.: 15/360,096

(22) Filed: Nov. 23, 2016

Related U.S. Application Data
(60) Provisional application No. 62/259,837, filed on Nov. 25, 2015.

(51) Int. Cl. H04L 12/24; H04L 29/06; H04L 29/08

(52) U.S. Cl. CPC H04L 41/0896; H04L 67/02; H04L 69/22; H04L 67/2804

(57) ABSTRACT

In general, one aspect of the subject matter described in this specification can be embodied in methods that include distributing bandwidth capacity among devices. The distribution includes receiving communications from devices that result from presentations made through user interfaces of the devices, each of the received communications including information about the presentation and the identity of the device. The distribution also includes determining a match between the identity of the device and stored information about devices. As a result of the match, the distribution includes sending a communication to the device that associates a possible distribution of an amount of bandwidth capacity with an event that may occur on the device as a result of a subsequent presentation. The distribution includes receiving a communication indicating that the event has occurred. As a result, the distribution includes distributing the amount of bandwidth capacity for use on the device.

### CLAIM OF PRIORITY

This application claims priority under 35 USC §119(e) to U.S. Patent Application Ser. No. 62/259,837, filed on Nov. 25, 2015, the entire contents of which are hereby incorporated by reference.

### BACKGROUND

This description relates to efficient allocation of bandwidth among devices.

As shown in FIG. 1 one paradigm for allocating bandwidth among competing devices is for a network operator to allocate bandwidth for use on different devices. The devices generally receive network access from a network operator, whether it is wired access 16 (from cable companies 17 such as Comcast or fixed telephony such as Verizon) or wireless access 18 (from companies 19 such as AT&T and Verizon). Typically, bandwidth available from the network operators is shared among multiple devices that compete for the available bandwidth.

Wired access to the Internet is usually tied to a specific device 20 at a specific location 22 (such as a modem 24) and sometimes restricted to specific devices attached to that modem. Wireless access, by its nature, cannot be restricted to a specific location so it is typically tied to a device 26, such as a tablet or a smartphone.

Internet access is typically distributed in terms of a certain amount of bandwidth capacity that is traditionally measured in bytes, over the course of a time period, typically a month; this capacity is often referred to as ‘data bandwidth’, e.g., the capacity to deliver up to a fixed number of bytes over a network (wired or wireless). We sometimes use the terms total bandwidth, capacity, quota, usage, and allotment interchangeably.

Bytes of information 30 delivered over a wired or wireless Internet connection is, in most modern networks, distributed using standard TCP/UDP transport protocols and packaged as IP packets forming a session. Each delivered IP packet is expressed in a number of bytes, which counts towards bandwidth capacity allotments by the network operator.

To allocate distributed bandwidth capacity, Internet services can have a variety of usage limits. Some services are considered to have an ‘unlimited’ allotment that is the bandwidth capacity usage is theoretically not metered and the devices can use of any amount without any restrictions. However, in practice, restrictions often exist and policies are put in place to guarantee the continued viability of the Internet service for all devices. Typically, the throughout, e.g., the speed at which the IP packets carrying the content are delivered, is dynamically throttled by the operator to mitigate the negative impact unlimited usage can have on the network and effectively distribute bandwidth capacity. Throughput is typically throttled when usage passes some threshold, considered to be excessive, or the network is congested. In both cases, throttling throughput has the negative impact of impairing most modern services.

The majority of mobile Internet services are limited and have quotas associated with them.

Bandwidth capacity may be used, for example, to carry applications 32 (e.g., games, software) or files 34 (e.g., music, movies) or subscribe to content-based services 36 (e.g., audio or video streaming, Internet TV, online magazines, online news) or communication services 38 (e.g. voice, messaging, chat, video communication). These applications, content, and services are sometimes offered directly by the same companies 17, 19 offering network access as add-ons or sometimes are purchased from third-party providers 40, such as Netflix 42. Applicable bandwidth capacity usage quotas must be reconciled with the amount of bandwidth capacity usage across all the services they subscribe to and all the devices they own. As wireless network speeds keep on getting faster than ever (4G LTE speeds can be faster than fixed broadband) and Internet-based content and services are delivered in greater number and higher quality, e.g. require more bandwidth, this model of delivery may be unsustainable.

When applications, content, and services (we sometimes refer to all of them using only one of the words: applications, services, content) are distributed through the Internet, the distribution uses bandwidth capacity.

On certain networks, such as cable, usage of bandwidth capacity is not necessarily separately metered or tracked.

Similarly, when Amazon introduced the first Kindle, its landmark capability was to be able to download any electronic book available in the store, anywhere in the United States, in less than 60 seconds. The bandwidth capacity used on the wireless network was not metered independently. Indeed, Amazon secured an agreement with a national wireless network provider to sell wholesale bandwidth to power the service and included the cost of the wireless distribution as part of the purchase price of the electronic book.

In both cases, a single provider, acting as the distributor and gatekeeper, controlled the value equation and the bundling of content, and distribution was tied and restricted to specific devices (the cable ‘box’ in the case of television and the Kindle eBook reader in the case of Amazon).

### SUMMARY

One aspect of the subject matter described in this specification can be embodied in methods that include the actions of distributing bandwidth capacity of a mobile communication network among devices that have access to the mobile communication network and use bandwidth capacity to receive from servers files to be used on the devices, the distributing of the bandwidth capacity including receiving communications from devices that result from presentations made through user interfaces of the devices, each of the received communications comprising information about the presentation from which it resulted and the identity of the device. The distributing bandwidth capacity includes determining a match between the identity of the device and stored information about devices. As a result of the match, sending a communication to the device that associates a possible distribution of an amount of bandwidth capacity with an event that may occur through the user interface of the device as a result of a subsequent presentation on the device that presents the possible distribution. Distributing the bandwidth capacity includes receiving a communication indicating that the event has occurred at the device. As a result of receiving the communication indicating that the event has occurred, distributing the amount of bandwidth capacity for use on the device.

The foregoing and other embodiments can each optionally include one or more of the following features, alone or in combination.

The received communications may include at least one of a subscriber identifier, a mobile telephone number, and an MSISDN inserted to a header of the HTTP request. One of the devices may not have a bandwidth allocation on the mobile operator network. Distributing the amount of bandwidth capacity device may include providing an incremental credit of a predetermined size to a bandwidth allocation associated with device. The methods may include determining, by the device, that a threshold amount of the bandwidth has been consumed and that the presentation has not been completely presented and requesting, by the device, an additional amount of bandwidth.

Particular embodiments of the subject matter described in this specification can be implemented so as to realize one or more of the following advantages. Users may access data without requiring a data plan. Content providers can provide equal access to their content without worrying about restrictions applied to their users. Available bandwidth capacity may be efficiently distributed based on usage.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a general functional architecture.

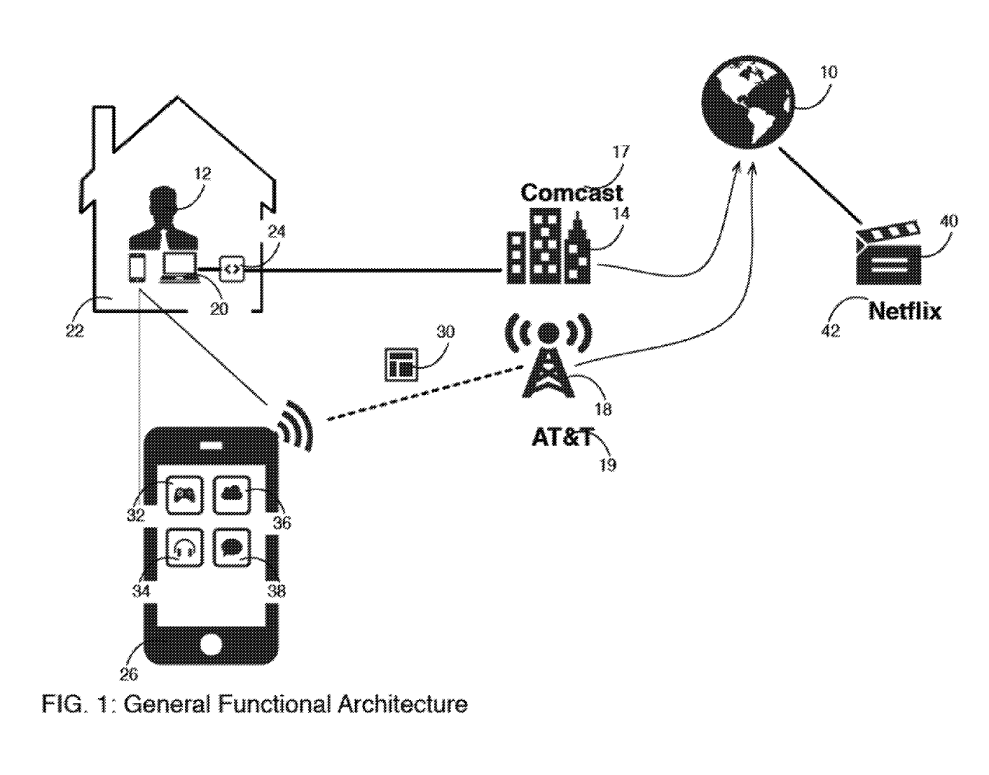

FIG. 2 illustrates a bandwidth capacity distribution platform.

FIG. 3 illustrates a bandwidth capacity distribution platform interacting with a client and mobile operator network.

FIG. 4 is a sequence diagram.

FIG. 5 is a sequence diagram.

Like reference numbers and designations in the various drawings indicate like elements.

### DETAILED DESCRIPTION

Global Web companies look to the emerging world as a source of future growth. For example, FACEBOOK has been looking to obtain its next billion users by focusing on emerging markets. These markets have growing smartphone penetration but have relatively low mobile data plan penetration.

App developers and marketers are paying increasing attention to these regions, but as smartphones continue to bring more people online, data-plan costs and other hurdles are preventing people from using mobile Internet services.

These applications increase the data usage and can put a strain on a cellular network. In response, many network providers control bandwidth through using bandwidth caps. A bandwidth cap limits the transfer of a specified amount of data over a period of time. Internet service providers commonly apply a cap when a channel intended to be shared by many users becomes overloaded, causing a strain on the provider.

In order to attempt to convince network providers to allow from targeted uncapped bandwidth, content providers have looked to techniques such as “zero rating.” “Zero rating” generally includes waiving data charges for certain traffic (e.g. data traffic measured in bytes for certain services/applications is not counted against a user data quota). The network of mobile operators recognize specific traffic to be served at no data charge to the subscribers and will typically charge another, sponsoring, entity in lieu of the subscriber.

One downside to traditional zero-rating for a specific Internet media assets is a very expensive and a difficult task for a mobile operator to perform at scale. In real-time, carrier networks need to identify and mark traffic flows related particular applications and content from amongst millions of other concurrent flows. Once identified, carrier networks need to precisely account for the data usage associated with these flows and instruct their billing and charging systems to charge a different party in lieu of the mobile subscribers.

The process is rendered more complex due to the ways media and content companies are distributing their assets over the Internet to optimize for delivery speed and reduce load time. For example, media and content companies can deliver content through the use of Content Distribution Networks (CDN) and distributed, geo-located and geo-cached architectures. In general, a CDN is a large distributed system of servers deployed in multiple data centers across the Internet. The CDN is designed to serve content to users with high availability and high performance. CDNs serve a large fraction of the Internet content today, including web objects (text, graphics and scripts), downloadable objects (media files, software, documents), applications (e-commerce, portals), live streaming media, on-demand streaming media, and social networks.

Content delivered by a CDN can involve dynamically generating a dynamically generated uniform resource locator (URL) for a client to obtain a giving media asset. A different URL or Internet Protocol (IP) Address may be generated for the same resource depending on the physical location of the client initiating the request, time of day, type of device and numerous other variables. The dynamic nature of URLs make it very challenging and nearly impossible for a mobile network operator to implement fixed rules, policies or signatures that would match specific media assets and instruct other parts of their network to zero-rate it for their subscribers.

In many cases, the actual size of the media asset to be zero-rated is known in advance or communicated in real-time as the device makes the request. Instead of identifying network flows, a system can effectively provide zero-rating in a mobile operator network by crediting or reimbursing the user with an equal amount of mobile data as it would otherwise use for media asset to be zero-rated. That is, the bandwidth that is normally be debited to the account of the user device would, instead, be debited to the content provider.

For instance, a mobile app publisher could provide “free-shipping” service to prospective users and entice them to download their mobile app at no data charge. Similarly, a music service could provide zero effective zero-rating service of the service through mobile data crediting as part of a subscription package.

In order to support mobile data crediting in lieu of in-network zero-rating, the system may include two components: (a) an integration with the billing systems of mobile network operators and (b) a way to determine the size of the assets to be credited back to the subscriber.

A platform and a system capable of interfacing in various ways with billing and charging systems of mobile network operators that enables arbitrary amount of mobile data (for instance 11 MB) can be added onto a subscriber data allotment (data buckets), was described in U.S. application Ser. No. 13/893,744 entitled CHARGING AND BILLING FOR CONTENT, SERVICES, AND ACCESS, incorporated in its entirety herein by reference.

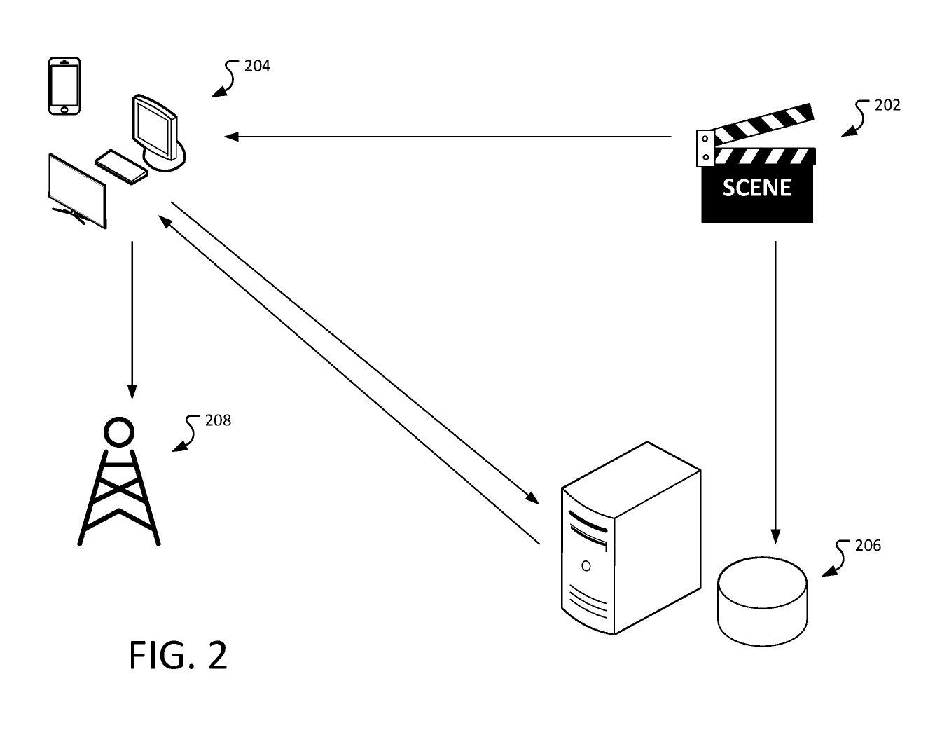

FIG. 2 illustrates an example of a bandwidth allocation system. A service provider 202 that wishes to ensure that user devices 204 receive sufficient bandwidth to maintain unexpected quality of service may distribute bandwidth to the user devices as follows. The service provider 202 provides the service or content to a device of the user devices 204. The service provider 202 notifies a bandwidth allocation system 206 that the device is to be allocated a predetermined amount of bandwidth. The service provider 202 may also provide information sufficient for the bandwidth allocation system 206 to identify the device. Examples of devices can include, but are not limited to, smart phones, computers, smart televisions, etc.

In some implementations, the allocation of bandwidth may be accompanied or provided based on a triggering event. The triggering event can be, for example, engagement with the service provided by the service provider 202 or viewing content provided by the service provider 202. In response to determining that the triggering event has occurred, the service provider 202 may inform the bandwidth allocation system 206 to allocate bandwidth to the triggering device.

The device sends a request to the bandwidth allocation system 206 requesting bandwidth. The bandwidth allocation system 206 compares information identifying the device (such as an MSISND) with stored information identifying bandwidth allocations. The bandwidth allocation system 206 provides to the device a token or some other indication that the device has been allocated the bandwidth.

The device can provide the token or other indication of bandwidth allocation to a network operator 208. The network operator 208 allocates bandwidth to the device upon receiving the token. In some implementations, the bandwidth allocation system 206 may communicate directly with the network operator 208. For example, the device may request bandwidth from the bandwidth allocation system 206 and the bandwidth allocation system 206 may contact the network operator 208 directly. In some implementations, the bandwidth allocation may be distributed as a credit to the account of a mobile device operating on a metered wireless network.

In many scenarios, network operators make money by providing network bandwidth to subscribers or affiliated devices (for example, a network operator may charge $10 per gigabyte of bandwidth). Accordingly, the bandwidth allocation system 206 may provide financial credits or an agreement to provide financial compensation to the network operator as part of the token or other indication of bandwidth allocation. Accordingly, the distribution of bandwidth capacity on a communications network may include a cost shifting component whereby a service or content provider provides financial compensation to the network operator.

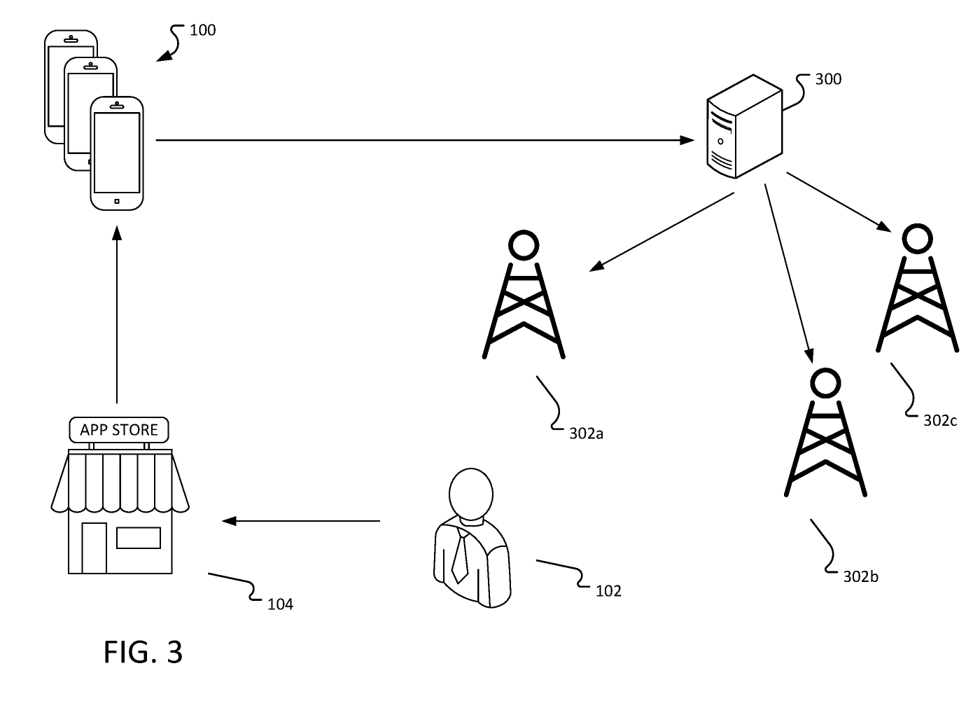

FIG. 3 illustrates another example of a bandwidth allocation system. A service provider 302a-c, for example a content provider or other provider that wishes to secure a reliable amount of bandwidth for a subscriber or user of the system, may provide content or a service to a user device form among user devices 304. The user device may be, for example, a computer, smart television, smart phone, or any other device that uses bandwidth to access the service. The service provider 302a-c can notify a bandwidth capacity distribution platform 306 that is wishes to provide a predetermined amount of bandwidth to the user device. The service provider 302a-c begins providing the content or service to the user device. The bandwidth capacity distribution platform 306 may store a record that indicates the amount of bandwidth to provide and an identifier that can be used to identify the user device.

The user device can contact the bandwidth capacity distribution platform 306 to request bandwidth. The bandwidth capacity distribution platform 306 compares information about the user device with the information stored information. The bandwidth capacity distribution platform 306 identifies the amount of bandwidth associated with the user device and provides a token (or other indication of the bandwidth allocation) to the user device.

The user device can provide the token to their network operator 308. The network operator may then provide the allocated bandwidth to the user device.

In some implementations, the bandwidth capacity distribution platform 306 may communicate directly with the network operator 308, bypassing the need to provide a token to the user device.

In conventional networks, the network operator 308 may provide bandwidth to a user device for a fee. For example, the user device may have an agreement with the network operator to receive 1 gigabyte of bandwidth in exchange for a monthly charge. One way a bandwidth capacity distribution platform may allocate bandwidth to the user device may be to pay the network operator for the bandwidth that is going to be used by the user device. Accordingly, one type of bandwidth capacity distribution platform is a split-billing platform.

For example, referring to FIG. 3, a split-billing platform 300 can serve a large number of mobile devices 100 each of which runs a collection of mobile applications. At least some of the mobile applications can be designed to be able to communicate with the split-billing platform.

The applications can include applications that are built using tools and frameworks provided by the mobile device vendor and that include a Software Development Kit (SDK) to communicate with the split-billing platform 300. The SDK can be included in the software binary of the mobile application at compilation time to run on the mobile devices 100. In some implementations, the SDK may be available as a library or application within the operating system of the mobile device 100. The applications can also be constructed to be able to communicate with the split-billing platform 300 using standard-based web technologies that can be executed inside a web browser. In this context, a web object, linked to the web application, can be used to communicate with the split-billing platform 300 (for example, using HTML5, CSS, and/or JavaScript).

Through the use of the SDK and/or the web technologies interface, the split-billing platform can track data flows

The platform is accessible to 3rd-parties through various means such as a Software Development Kit (SDK) incorporated in mobile clients and/or an Application Programming Interface (API) for mobile clients and web services alike. Using an interface to the crediting platform, a client or a 3rd-party backend service is able to instruct the crediting platform to initiate a credit transaction with the mobile operators' billing and charging system the subscriber is currently provisioned on.

In general, the platform is capable of interfacing with mobile operator networks to allocate credit to a particular mobile device, or the account of a particular mobile device. For example, the platform can request that a mobile operator network provide 300 MB of wireless data credit. In some implementations, the mobile operator network can provide an identity of an individual who has agreed to pay for the 300 MB to the wireless network operator so that the wireless network operator can bill the correct party. In other implementations, the wireless network operator bills the platform and the platform charge individuals who agree to provide the bandwidth.

For example, a developer 102 may place a mobile app on an app store 104. The App store can be, for example, the APPLE App store. The developer 102 determines to offer the mobile app zero-rated. That is, the user downloading the mobile app will not be charged for the bandwidth associated with the download. The developer 102 may contract with the split-billing platform 300. When a mobile device 100 downloads the application, the split billing platform can be provided with identifying information about the mobile device, such as an account or subscriber number, and an amount of data used to download the mobile applications. As discussed further below, the amount of data used can be provided by either a server, such as the app store 104 or by the mobile device 100. The split-billing platform 300 can communicate with the appropriate mobile operator network to provide bandwidth credit to the mobile device and to, instead, charge the developer 102 for the bandwidth.

Determining the size of the assets to be credited back can be accommodated in various ways. The size of the asset can be determined by a server before the asset is delivered or by the client after the asset is delivered.

A priori, assets sizes, such as mobile app binaries, video or audio assets, etc. are known from their creators and services serving them on the Internet. For instance an app publisher creating a marketing promotion in a storefront for a “free-shipping” app download could post the size of his app binary on the marketing provisioning portal. In addition, Internet protocols used to fetch assets on the Internet have built-in asset size request capabilities. This is the case for instance for the HTTP protocol used in 90% of the transactions on the Internet. Additionally, the assets sizes may be posted on storefronts and can be easily retrieved by clients. For instance, the APPLE App Store and the GOOGLE Play Store post the sizes of mobile app binaries.

A posteriori, and once retrieved, the size of the asset is known by the client

Detecting whether certain assets are eligible for a data credit is performed through an exchange with the platform described in U.S. patent application Ser. No. 13/893,870 entitled “ADVERTISER SUPPORTED BANDWIDTH PLATFORM” and incorporated herein in its entirety by reference. Determining whether certain assets are eligible are typically performed as part of a marketing campaign provisioned by the entity wishing to effectively zero-rate certain assets. In general, a content provider may offer zero-rated content. The zero-rated content may be offered, for example, as part of a promotional campaign or as part of a regular subscription service.

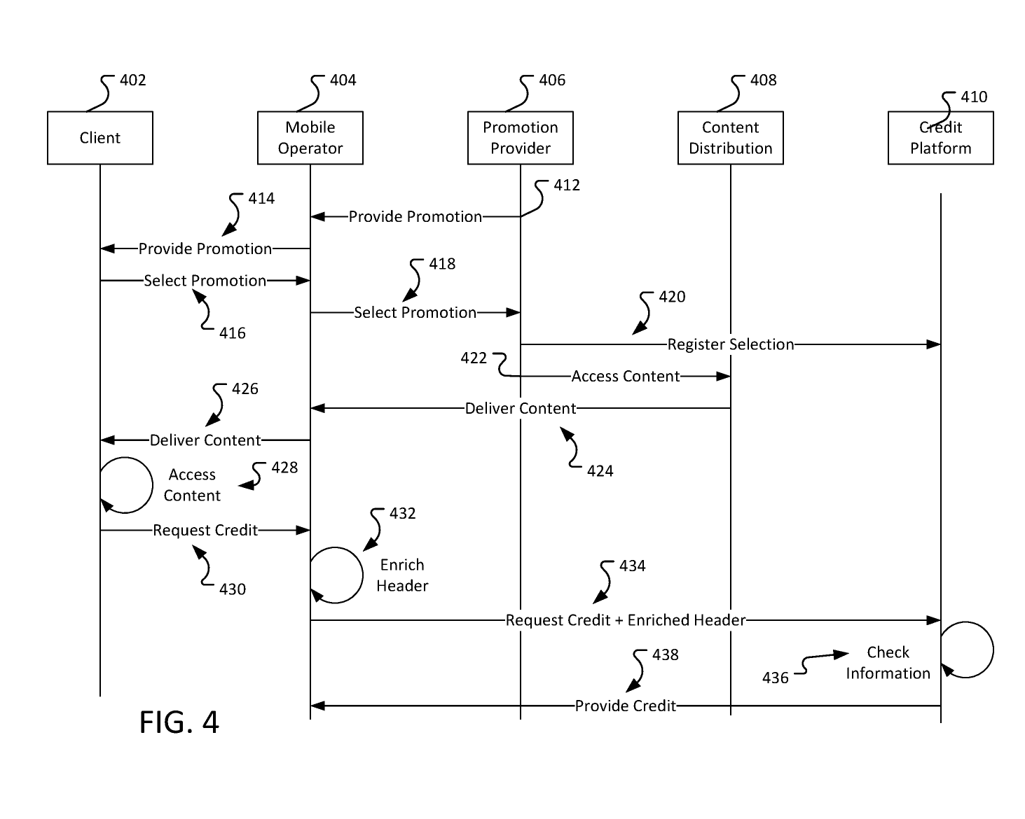

FIG. 4 is a sequence diagram illustrating an example of providing credit to a mobile account when the size of the asset is determine a posteriori. Generally, communications between the client 402 and the mobile operator network 404 utilize bandwidth for which the client 402 may be debited (or may be counted against a predetermined data allowance) by the mobile operator network.

A client 402 receives a promotion 412, 414 from a promotion provider. The promotion may be delivered to the client 402 through the Internet. The promotion may be delivered using conventional transmissions to a mobile operator network 404, for example, using a backhaul network. The mobile operator network 404 provides the promotion to the client device 414, using a wireless protocol, for example, using a 3G, 4G, or LTE communication protocol. In some implementations, an offer to download zero-rated content may be provided on a website or through an advertisement that is accessed by the client. In some implementations, the offer to download zero-rated content may be provided in the form of an electronic mail, text message, or other means of communication.

When the client accepts the promotional offer (for example, clicks or otherwise selects a link to download the content), a message is sent 416, 618 (via the mobile operator network) to the promotion provider 406. The promotion provider 406 registers 420 the selection with a credit platform 410. In some implementations, the registration is associated with a token or information identifying the client (for example, the MSISDN). Other information can be used as the token, for example, a subscriber identifier or a cryptographically secure randomly generated number.

The promotion provider can process access to the content 422 on a content distribution service 408, for example, by using conventional forwarding techniques. In some implementations, selecting the promotional offer navigates the client directly to the content distribution service. The content distribution service then registers the selection of the promotion with the credit platform.

The content distribution service 408 delivers 424, 426 the requested content to the client 402, via the mobile operator network.

The client may access 428 the content. For example, by executing an application, or accessing particular content within an application. If an asset is eligible for a credit, the client retrieving the assets can request the crediting platform 430, 434 initiate the crediting transaction.

The instruction can be provided to the crediting platform though credit transaction call made using an SDK or API exposed by the crediting platform. The request is routed through the mobile operator network.

The mobile operator network 404 may enrich 422 the request sent by the client 402. For example, the credit transaction request made over the mobile operator network 404 can be enriched with additional information to identify the subscriber. This information may be predetermined by agreement between the mobile operator network 404 and the crediting platform 410. Enriched information may include their mobile phone number or any other unique identifier allowing a particular subscriber to be uniquely identified. In some implementations, the information may be included in a HTTP header. In general, HTTP header enrichment is a technique where a special field is inserted into in the HTTP header carrying the payload. For example, the client may add a “subscriber” field to the HTTP header. The value of the subscriber field may uniquely identify the subscriber. The crediting platform can use the provided unique subscriber identifier to initiate the crediting transaction (for example, add 123 MB to the account of subscriber matching subID 123 or with mobile telephone number (555) 1234-123) (MSISDN).

The request for credit, enriched with the subscriber information, is provided to the crediting platform 410. The credit platform 410 can compare the information provided with the request (for example, the enrichment information provided on the header) with the registered selection information. For example, the credit platform may compare an MSISDN included in the enrichment header with the MSISDN registered by the content provider or promotion provider.

The credit platform 410 can check 436 the subscriber information. If the credit platform 410 determines that the information from the request matches the registered information, then the credit platform 410 may provide 438 bandwidth credit to the account of the client with the mobile operator network 404. The crediting transaction is typically performed in real-time but some older billing and charging system can process the crediting transaction in delayed batches. In this scenario, the client and the crediting platform can coordinate to initiate a pre-deposit ahead of time that is thought to cover the size of assets at the time they are retrieved.

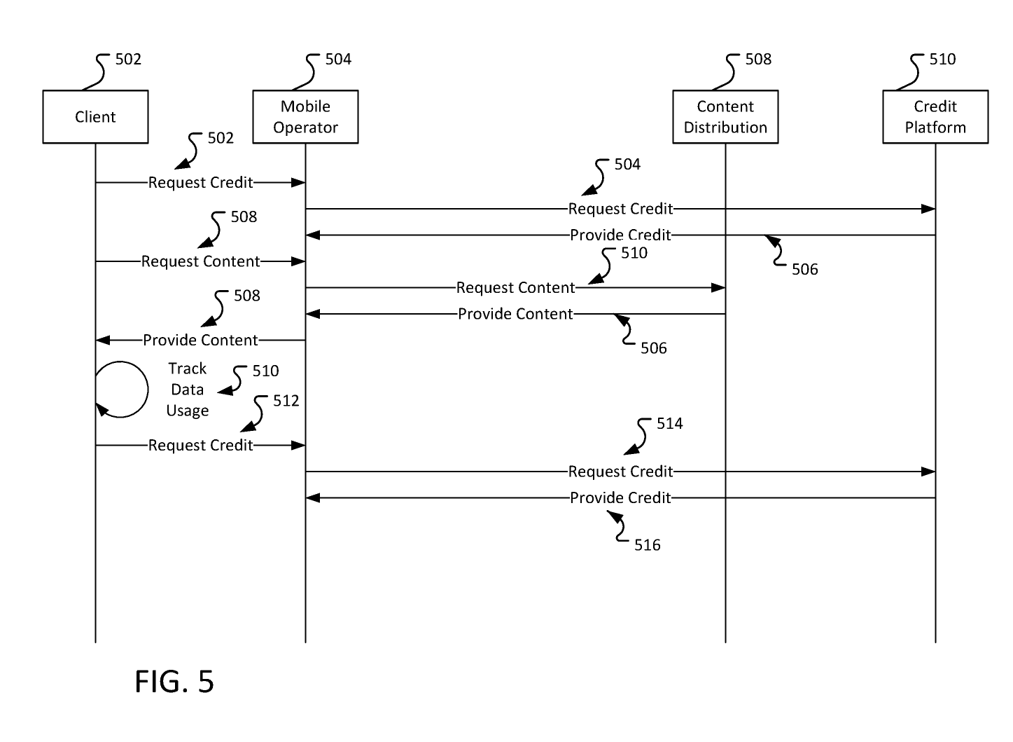

FIG. 5 is a sequence diagram illustrating enabling zero-rated access to clients without a data allowance. In some implementations, a client without a data allowance on their account may still be eligible for effective zero-rating through data crediting. Generally, zero-rating credits are provided after the fact. That is, the client uses a portion of their bandwidth to obtain the content and, at a later time, the bandwidth is credited back to the user or the charging and billing systems are instructed not to charge the user for the zero-rated usage. A subscriber without any data allowance may be denied access to the mobile operator network, and therefore, not be able to access the zero-rated transaction.

In some implementations, credit can be granted to clients prior to downloading the zero-rated content.

The client 402 can sent a request 502, 504 to the credit platform 410 for credit. The credit platform may have an agreement with the mobile operator network to allow the client to send requests to the credit platform without a data allowance. If the size of the content is known at the time it is requested (for instance through the HTTP request to retrieve the content), the client can request the crediting platform to provide sufficient credit for the zero-rated content to be downloaded.

For the situation where the size of the assets are not known at the time it is requested, the client 402 and the crediting platform 410 can coordinate to perform a progressive crediting. As the client 402 downloads, the crediting platform 410 can provide a sequence of smaller credits the content until the retrieval of eligible assets is completed. In this example, a client 402 is streaming a movie for which the size is not known, the client 402 can instruct 502, 504 the crediting platform 410 to initiate a progressive credit, for instance 20 MB. The crediting platform 410 provides 506 the requested credit.

The client 410 is then able to start streaming the content. The client 402 requests 508, 510 the content from the content distribution service 408. The content distribution service 408 provides 512, 514 the requested content.

The client 402 may track 510 the amount of data received from the content distribution service 408. Alternatively, the content distribution service may track the amount of content delivered to the client device.

When a predetermined portion of the credit has been consumed (for example, when the client has used 85%, 90% or 95% of the available bandwidth credit) and the content has not been completely delivered (for example, the video streaming is not completed), the client 402 can request 512, 514 that the crediting platform 410 make another deposit. The crediting platform provides 516 another credit increment with the mobile operator network 404. This process continues until the client informs the crediting platform that the retrieval of asset is completed.

In some scenarios, if supported by the mobile operator network's billing and charging systems, a reserve credit transaction can be initiated to null unused credits.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs (i.e., one or more modules of computer program instructions, encoded on computer storage mediums for execution by, or to control the operation of, data processing apparatus). A computer storage medium can be, or be included in, a computer-readable storage device, a computer-readable storage substrate, a random or serial access memory array or device, or a combination of one or more of them. The computer storage medium can also be, or be included in, one or more separate physical components or media (e.g., multiple CDs, disks, or other storage devices). The computer storage medium can be non-transitory.

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example, a programmable processor, a computer, a system on a chip, or multiple ones, or combinations, of the foregoing. The apparatus can include special purpose logic circuitry (e.g., an FPGA (field programmable gate array) or an ASIC (application-specific integrated circuit)). The apparatus can also include, in addition to hardware, code that creates an execution environment for the computer program in question (e.g., code that constitutes processor firmware, a protocol stack, a database management system, an operating system, a cross-platform runtime environment, a virtual machine, or a combination of one or more of them). The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry (e.g., an FPGA (field programmable gate array) or an ASIC (application-specific integrated circuit)).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive, data from or transfer data to, or both, one or more mass storage devices for storing data (e.g., magnetic, magneto-optical disks, or optical disks), however, a computer need not have such devices. Moreover, a computer can be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive)), to name just a few. Devices suitable for storing computer program instructions and data include all forms of non-volatile memory, media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback) and input from the user can be received in any form, including acoustic, speech, or tactile input. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back-end component (e.g., as a data server),a middleware component (e.g., an application server), or a front-end component (e.g., a user computer having a graphical user interface or a Web browser through which a user can interact with an implementation of the subject matter described in this specification), or any combination of one or more such back-end, middleware, or front-end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some embodiments, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can, in some cases, be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
distributing bandwidth capacity of a mobile communication network among devices that have access to the mobile communication network and use bandwidth capacity to receive from servers files to be used on the devices, the distributing of the bandwidth capacity comprising
receiving communications from devices that result from presentations made through user interfaces of the devices, each of the received communications comprising information about the presentation from which it resulted and the identity of the device,
determining a match between the identity of the device and stored information about devices,
as a result of the match, sending a communication to the device that associates a possible distribution of an amount of bandwidth capacity with an event that may occur through the user interface of the device as a result of a subsequent presentation on the device that presents the possible distribution,
receiving a communication indicating that the event has occurred at the device, and
as a result of receiving the communication indicating that the event has occurred, distributing the amount of bandwidth capacity for use on the device.

2. The computer-implemented method of claim 1, wherein the received communications includes at least one of a subscriber identifier, a mobile telephone number, and an MSISDN inserted to a header of the HTTP request.

3. The computer-implemented method of claim 1, wherein at least one of the devices does not have a bandwidth allocation on the mobile operator network.

4. The computer-implemented method of claim 1, wherein distributing the amount of bandwidth capacity includes providing an incremental amount of bandwidth of a predetermined size to a bandwidth allocation associated with device.

5. The computer-implemented method of claim 4, further comprising:
determining, by the device, that a threshold amount of the bandwidth has been consumed and that the presentation has not been completely presented; and
requesting, by the device, an additional amount of bandwidth.

6. The computer-implemented method of claim 1, further comprising:
removing an excess bandwidth allocation from the account of the device once the presentation has been presented.

7. An electronic system comprising:
one or more processing devices; and
one or more machine-readable media configured to store instructions that are executable by the one or more processing devices to perform operations comprising:
distributing bandwidth capacity of a mobile communication network among devices that have access to the mobile communication network and use bandwidth capacity to receive from servers files to be used on the devices, the distributing of the bandwidth capacity comprising
receiving communications from devices that result from presentations made through user interfaces of the devices, each of the received communications comprising information about the presentation from which it resulted and the identity of the device,
determining a match between the identity of the device and stored information about devices,
as a result of the match, sending a communication to the device that associates a possible distribution of an amount of bandwidth capacity with an event that may occur through the user interface of the device as a result of a subsequent presentation on the device that presents the possible distribution,
receiving a communication indicating that the event has occurred at the device, and
as a result of receiving the communication indicating that the event has occurred, distributing the amount of bandwidth capacity for use on the device.

8. The electronic system of claim 7, wherein the received communications includes at least one of a subscriber identifier, a mobile telephone number, and an MSISDN inserted to a header of the HTTP request.

9. The electronic system of claim 7, wherein at least one of the devices does not have a bandwidth allocation on the mobile operator network.

10. The electronic system of claim 7, wherein distributing the amount of bandwidth capacity includes providing an incremental amount of bandwidth of a predetermined size to a bandwidth allocation associated with device.

11. The electronic system of claim 10, further comprising:
determining, by the device, that a threshold amount of the bandwidth has been consumed and that the presentation has not been completely presented; and
requesting, by the device, an additional amount of bandwidth.

12. The electronic system of claim 7, further comprising:
removing an excess bandwidth allocation from the account of the device once the presentation has been presented.

13. A non-transitory machine-readable media configured to store instructions that are executable by one or more processing devices to perform operations comprising:
distributing bandwidth capacity of a mobile communication network among devices that have access to the mobile communication network and use bandwidth capacity to receive from servers files to be used on the devices, the distributing of the bandwidth capacity comprising
receiving communications from devices that result from presentations made through user interfaces of the devices, each of the received communications comprising information about the presentation from which it resulted and the identity of the device,
determining a match between the identity of the device and stored information about devices,
as a result of the match, sending a communication to the device that associates a possible distribution of an amount of bandwidth capacity with an event that may occur through the user interface of the device as a result of a subsequent presentation on the device that presents the possible distribution,
receiving a communication indicating that the event has occurred at the device, and
as a result of receiving the communication indicating that the event has occurred, distributing the amount of bandwidth capacity for use on the device.

14. The non-transitory machine readable media of claim 13, wherein the received communications includes at least one of a subscriber identifier, a mobile telephone number, and an MSISDN inserted to a header of the HTTP request.

15. The non-transitory machine readable media of claim 13, wherein at least one of the devices does not have a bandwidth allocation on the mobile operator network.

16. The non-transitory machine readable media of claim 13, wherein distributing the amount of bandwidth capacity includes providing an incremental amount of bandwidth of a predetermined size to a bandwidth allocation associated with device.

17. The non-transitory machine readable media of claim 16, further comprising:
determining, by the device, that a threshold amount of the bandwidth has been consumed and that the presentation has not been completely presented; and
requesting, by the device, an additional amount of bandwidth.

18. The non-transitory machine readable media of claim 13, further comprising:
removing an excess bandwidth allocation from the account of the device once the presentation has been presented.
